(19) United States
(12) Patent Application Publication
(10) Pub. No.: US 2012/0282048 A1
(43) Pub. Date: Nov. 8, 2012

(54) Insert With A Wiper To Induce Chip Thinning On A Leading Edge

(75) Inventor: Raja Kountanya, Manchester, CT (US)

(73) Assignee: DIAMOND INNOVATIONS, INC., Worthington, OH (US)

(21) Appl. No.: 13/462,411

(22) Filed: May 2, 2012

Related U.S. Application Data
(60) Provisional application No. 61/481,875, filed on May 3, 2011.

(51) Int. Cl. B23P 15/28; B21K 21/00

(52) U.S. Cl. 407/113; 76/101.1

(57) ABSTRACT

A cutting insert includes a body formed with at least one corner. The corner is formed with at least a first radius and a second radius disposed adjacent the first radius. The cutting insert may be adapted to be a part of a cutting tool.

### CROSS-REFERENCE RELATED APPLICATIONS

This patent application claims priority of U.S. provisional patent application No. 61/481875 filed May 3, 2011, entitled “Insert with a wiper to induce chip thinning on a leading edge”, the disclosure of which is incorporated herein by reference in its entirety.

### TECHNICAL FIELD AND INDUSTRIAL APPLICABILITY

The present disclosure relates to an insert with a wiper and a method of manufacturing the insert. More particularly, the present disclosure relates to an insert with a wiper to induce chip thinning on the leading edge of the insert without a significant decrease in insert access and a method of manufacturing the insert.

### BACKGROUND

In the discussion of the background that follows, reference is made to certain structures and/or methods. However, the following references should not be construed as an admission that these structures and/or methods constitute prior art. The inventor expressly reserves the right to demonstrate that such structures and/or methods do not qualify as prior art.

In cutting tools for machining, cutting inserts may be adapted to be part of the cutting tool. When machining some difficult-to-machine materials where there is pronounced chipping and breakage near a zone of maximum uncut chip thickness in a cutting area, it is beneficial to thin the chip with a larger radius. However, a larger radius reduces the accessibility or “reach” of the insert.

Accordingly, there is a need in the art for an insert that is better adapted to induce chip thinning without a significant decrease in the reach of the insert.

### SUMMARY

An exemplary cutting insert includes a body formed with at least one corner, and the corner is formed with at least a first radius and a second radius disposed adjacent the first radius.

An exemplary method of manufacturing a cutting insert includes providing a body, and forming a corner on the body with a first radius and a second radius disposed adjacent the first radius.

It is to be understood that both the foregoing general description and the following detailed description are exemplary and explanatory and are intended to provide further explanation of the invention as claimed.

### BRIEF DESCRIPTION OF THE DRAWINGS

The following detailed description can be read in connection with the accompanying drawings in which like numerals designate like elements and in which:

FIG. 1 is a perspective view of an insert in accordance with an exemplary embodiment;

FIG. 2 is a plan view of the insert shown in FIG. 1;

FIG. 3 is a partial plan view in detail of a portion of the insert shown in FIG. 1;

FIG. 4 is a partial plan view in detail of another portion of the insert shown in FIG. 1;

FIG. 5 is a side elevational view of the insert shown in FIG. 1;

FIG. 6 is a partial side elevational view in detail of a portion of the insert shown in FIG. 5;

FIG. 7 is a perspective view of an insert with a wiper in accordance with another exemplary embodiment;

FIG. 8 is a perspective view of an insert with a corner radius;

FIG. 9 is a graph of uncut chip thickness and angular position for the inserts shown in FIGS. 7 and 8;

FIG. 10 is a perspective view of an insert with a wiper in accordance with yet another exemplary embodiment;

FIG. 11 is a perspective view of an insert with a corner radius;

FIG. 12 is a graph of uncut chip thickness and angular position for the inserts shown in FIGS. 10 and 11; and

FIG. 13 is a graph of life for cutting inserts with a corner radius only and for cutting inserts with a corner radius and a leading edge.

### DETAILED DESCRIPTION

In machining practice, at least three kinematic variables may be cutting speed, depth-of-cut, and feed-rate. The depth-of-cut and feed rate, resolved to the shape of the surfaces bounding the cutting edge, may produce an uncut chip area, which may include and be characterized by a maximum uncut chip thickness. The maximum uncut chip thickness can be the maximum incident work material area per unit width in a cross-section perpendicular to the cutting edge at a certain point inside the portion of the cutting edge engaged in contact with the workpiece producing the chip. Reducing the maximum uncut chip thickness without sacrificing productivity and flexibility can be an important goal in insert design. Productivity, for constant cutting speed, may be closely tracked by the uncut chip area, whereas flexibility is a result of number of considerations, one of which is insert reach, which is elaborated in the following.

Referring to the figures, a cutting insert 100 can be adapted to reduce an uncut chip thickness. The cutting insert 100 may have many different shapes; however, for the sake of simplifying the description thereof, an exemplary embodiment is described in reference to the cutting insert 100 shown in the figures. The cutting insert 100 shown in the figures may be referred to as a square cutting insert. However, the invention is not meant to be limited to only the cutting insert 100 shown and described.

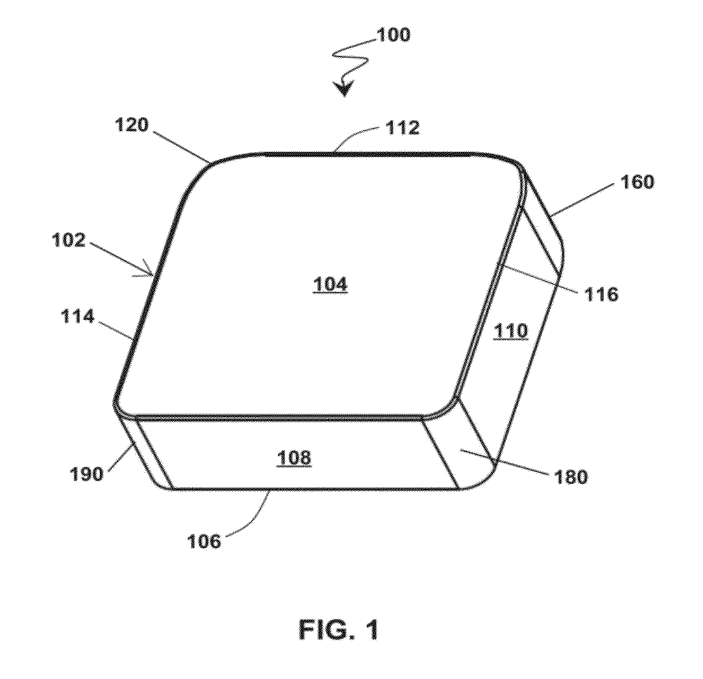

Turning to FIG. 1, the cutting insert 100 can include a body 102. The body may include a plurality of faces 104, 106, 108, 110, 112, and 114. In the embodiment shown in FIG. 1, the body 102 may include six faces 104, 106, 108, 110, 112, and 114. Alternatively, the body 102 may include have a different number of faces than the six faces 104, 106, 108, 110, 112, and 114 shown. In particular, in an alternative construction, the body 102 may include less than six faces or more than six faces. The exact number of faces 104, 106, 108, 110, 112, and 114 may be determined by the application, use, or some other criterion related to the cutting insert 100.

Also, in FIG. 1, two opposite faces may have a generally square shape as shown; however, the body 102 may be alternatively constructed to include one or more generally square, generally rectangular, generally rhomboid, or some other suitable polygonal shape, for example. The exact shape of each face 104, 106, 108, 110, 112, and 114 may be determined by the application, use, or some other criterion related to the cutting insert 100.

Furthermore, one of the plurality of faces 104, 106, 108, 110, 112, and 114 may be designated as the top face, and thus, an opposite face of the plurality of faces 104, 106, 108, 110, 112, and 114 may be designated as a bottom face. The faces joining the top face and the bottom face may be referred to as flank faces or side faces. In the embodiment shown in FIG. 1, face 104 may be the top face, and face 106 which may be opposite face of 104 may be the bottom face. Faces 108, 110, 112, and 114 which may extend from the top face 104 to the bottom face 106 may be the flank faces. In alternative constructions, there may be a different arrangement of faces 104, 106, 108, 110, 112, and 114, such that face 104 need not be the top face, face 106 need not be the bottom face, and faces 108, 110, 112, and 114 need not be the flank faces.

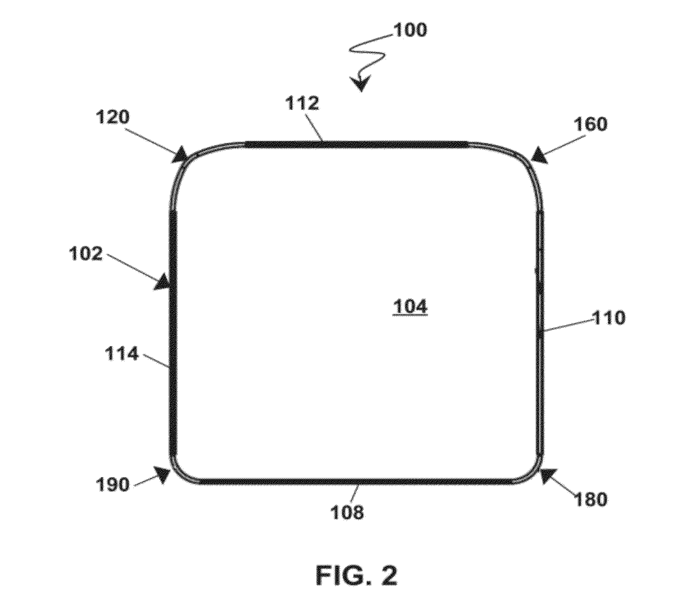

Referring to FIG. 2, the body 102 may include one or more corners 120, 160, 180, and 190. A corner 120, 160, 180, and 190 may be formed where a plurality of the faces 104, 106, 108, 110, 112, and 114 of the body 102 meet. In the embodiment shown, the body 102 may include four corners 120, 160, 180, and 190; however, the number of corners 120, 160, 180, and 190 is not meant to be limiting. In alternative constructions of the cutting insert 100, there may be less than or more than the four corners 120, 160, 180, and 190 shown. Also, in the embodiment shown, the corner 120 may be formed from faces 104, 112, 114, and 106; the corner 160 may be formed from faces 104, 112, 110, and 106; the corner 180 can be formed from faces 104, 110, 108, and 106; and the corner 190 can be formed from faces 104, 108, 114, and 106. In alternative constructions, the corners 120, 160, 180, and 190 may each be formed from a different combination of faces of the plurality of faces.

Each of the corners 120, 160, 180, and 190 may have a portion designated as a leading edge and another portion designated as a trailing edge. That is, one of the plurality of faces 104, 106, 108, 110, 112, and 114 may be designated as a leading edge, and another of the plurality of faces 104, 106, 108, 110, 112, and 114 may be designated as a trailing edge. For example, if the cutting insert 100 shown in FIG. 1 is to be a right-handed cutter, then the direction of cutting for the cutting insert 100 may be towards the left side of the FIG. 1. Thus, for corner 120, face 114 may be designated as the leading edge, and face 112 may be designated as the trailing edge. Alternatively, if the cutting insert 100 shown in FIG. 1 is to be a left-handed cutter, then the direction of cutting for the cutting insert 100 may be towards the right side of the FIG. 1. Thus, for corner 160, face 110 may be designated as the leading edge, and face 112 may be designated as the trailing edge. Each of the other corners 160, 180, and 190 may have a portion designated as the leading edge and another portion designated as the trailing edge.

In the embodiment shown in FIG. 2, the body 102 may have a width and height that are about 9.52 millimeters or about 0.375 inches, for example. In alternative constructions, the body 102 can have different dimensions for the width and height, and the width and height do not need to be equal.

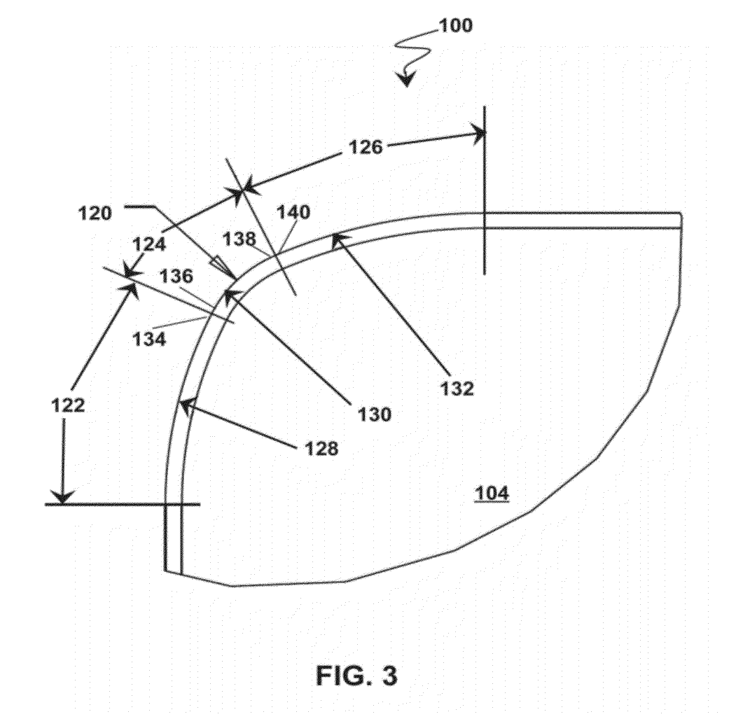

Referring to FIG. 3, the corner 120 is shown. The corner 120 may include a first arc 122, a second arc 124 being disposed adjacent to the first arc 122, and a third arc 126 being disposed adjacent to the second arc 124. The first arc 122 may be a circular arc defined by a first radius 128; the second arc 124 may be a circular arc defined by a second radius 130; and the third arc 126 may be a circular arc defined by a third radius 132. In an alternative construction, one or more of the arcs 122, 124, or 126 may not be a circular arc.

Also, the second radius 130 may sometimes be referred to as the corner radius. Reach may be defined as the distance between a center of the insert 100 to a center of any one corner radius, such as second radius 130. The second radius 130 may distribute a cutting load of the insert 100 over a larger portion of the insert 100. A larger second radius 130 may also provide a smoother finish to an object being cut by the insert 100. However, a larger second radius 130 may reduce a reach of the insert 100 or an accessibility of the insert 100. The second arc 124 with the second radius 130 may determine the reach of the insert 100. As the second radius 130 becomes larger, for a certain sized insert, a center of the second radius 130 moves towards the center of the insert, and thus, the center of the corner radius moves towards the center of the insert. When the second radius 130 becomes larger, the reach becomes smaller because, for a particular sized insert, the center of second radius 130 moves toward the center of the insert.

One or both of the first and third arcs 122 and 126 may sometimes be referred to as a wiper. Furthermore, if the insert 100 is a right-handed cutter, then the first arc 122 may be further referred to as a leading edge wiper, and the third arc 126 may be further referred to as a trailing edge wiper. If the insert 100 is a left-handed cutter, then the third arc 126 may be the leading edge wiper, and the first arc 122 may be the trailing edge wiper.

A wiper on the leading edge may have a different purpose than a wiper on the trailing edge. The wiper on the leading edge may adjust an uncut chip thickness of the object being cut by the insert 100. In combination with selected orientation angles of an insert holder, the maximum uncut chip thickness occurs on the leading edge. Thus, a wiper on the leading edge may then be provided for chip thinning effect or to produce a lower maximum uncut chip thickness. Also, the wiper on the leading edge may adjust the life of the insert 100. For example, in the embodiment shown, the wiper on the leading edge may increase the life of the insert 100.

A wiper on the trailing edge has a different purpose and function than the wiper on the leading edge. The wiper on the trailing edge may provide surface finishing treatment. For example, the wiper on the trailing edge may improve surface finish on a part. The embodiment shown may include a wiper on the trailing edge but the wiper on the trailing edge need not specifically improve surface finish. In alternate constructions or embodiments, an insert, such as insert 100, may include both wipers on the leading edge and the trailing edge to provide the same purpose or function or different purposes or functions. For example, wipers on both the leading edge and the trailing edge may provide improved surface finish, better reach, both better reach and improved surface finish, or some other advantage.

The first, second, and third arcs 122, 124, and 126 may form a compound curve, wherein the first, second, and third arcs 122, 124, and 126 may be consecutive tangent circular arcs. That is, the first arc 122 may transition smoothly into the second arc 124, and the second arc 124 may transition smoothly into the third arc 126. The first arc 122 may have a first tangent 134 at an end of the first arc 122, and the second arc 124 may have a second tangent 136 at an end of the second arc 124 disposed where the first arc 122 meets the second arc 124. The first tangent 134 and the second tangent 136 may be the same so that the first arc 122 and the second arc 124 may meet smoothly with no discontinuity. The second arc 124 may have another tangent 138 at another end of the second arc 124, and the third arc 126 may have a third tangent 140 at an end of the third arc 126 disposed where the third arc 126 meets the second arc 124. The other tangent 138 and the third tangent 140 may be the same so that the second arc 124 and the third arc 126 may meet smoothly with no discontinuity.

Also, there may be one or more additional arcs between the first arc 122 and the second arc 124 or between the second arc 124 and the third arc 126 so that the first arc 122 may be blended into the second arc 124 or the second arc 124 may be blended into the third arc 126. The one or more additional arcs may each be a circular arc, and each of the one or more additional arcs that are circular arcs may have a blending radius.

In alternative constructions, the first, second, and third arcs 122, 124, and 126 may not form a compound curve, or the first, second, and third arcs 122, 124, and 126 may not be consecutive tangent circular arcs.

The second radius 130 can be selected from one of a plurality of standard radii, such as the standard radii described in ISO 6897:1998(E), entitled “Indexable hard material inserts with rounded corners, with partly cylindrical fixing hole—Dimensions.” Thus, the second radius 130 can be about 0.4 millimeters, 0.8 millimeters, 1.6 millimeters, 3.2 millimeters, for example. However, the second radius 130 is not limited to standard radii, and in alternative constructions, the second radius 130 may be a non-standard radius. The second radius 130 may be determined by the application, use, or some other suitable criterion of the insert 100.

In the embodiment shown, the corner 120 may have a first arc 122 of about 25 degrees, for example, and a third arc 126 of about 25 degrees, for example. Also, the first arc 122 may have a first radius 128 of about 3.00 millimeters or about 0.118 inches, for example, and the third arc 126 may have a third radius 132 of about 3.00 millimeters or about 0.118 inches, for example. The second arc 124 may have a radius of 0.80 millimeters or about 0.032 inches, for example. The first and third arcs 122 and 126 and the first and third radii 128 and 132 are not limited to the ones described above. The first and third arcs 122 and 126 and the first and third radii 128 and 132 may be determined from the application, use, or some other criterion of the insert 100. For example, the first and third arcs 122 and 126 and the first and third radii 128 and 132 may be determined from the shape of the insert 100, the second arc 124, the second radius 130, or the shape of another adjacent feature.

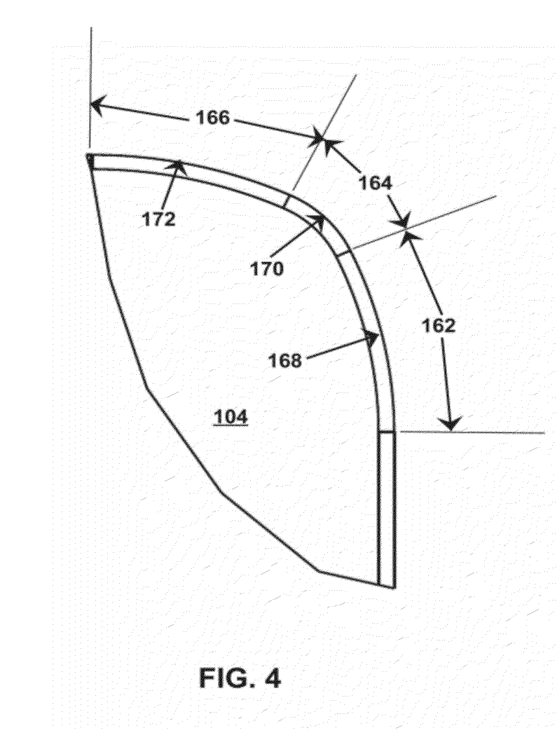

Referring to FIG. 4, one or more of the other corners 160, 180, and 190 may also each include a first arc with a first radius, a second arc with a second radius, and a third arc with a third radius. That is, one or more of the other corners 160, 180, and 190 may each have a predetermined corner radius with either a leading edge wiper, a trailing edge wiper, both a leading edge wiper and a trailing edge wiper, or no leading edge wiper and trailing edge wiper. The other corners 160, 180, and 190 may have the same corner radius as corner 120 or some other corner radius. If the other corners 160, 180, and 190 include a leading edge wiper, a trailing edge wiper, or both a leading edge wiper and a trailing edge wiper, the leading edge wiper and/or the trailing edge wiper may have an arc or radius that is different from the first and third arcs 122 and 126 or the first and third radii 128 and 132.

In FIG. 4, corner 160 may include a fourth arc 162, a fifth arc 164 being disposed adjacent to the fourth arc 162, and a sixth arc 166 being disposed adjacent to the fifth arc 164. The fourth arc 162 may be a circular arc defined by a fourth radius 168; the fifth arc 164 may be a circular arc defined by a fifth radius 170; and the sixth arc 166 may be a circular arc defined by a sixth radius 172. In an alternative construction, one or more of the arcs 164, 166, and 168 may not be a circular arc.

The fourth, fifth, and sixth arcs 162, 164, and 166 may form a compound curve, wherein the fourth, fifth, and sixth arcs 162, 164, and 166 may be consecutive tangent circular arcs. That is, the fourth arc 162 may transition smoothly into the fifth arc 164, and the fifth arc 164 may transition smoothly into the sixth arc 166. Each of the fourth, fifth, and sixth arcs 162, 164, and 166 may include tangents that are substantially the same as an adjacent tangent of another arc 162, 164, or 166. In alternative constructions, the fourth, fifth, and sixth arcs 162, 164, and 166 may not form a compound curve, or the fourth, fifth, and sixth arcs 162, 164, and 166 may not be consecutive tangent circular arcs.

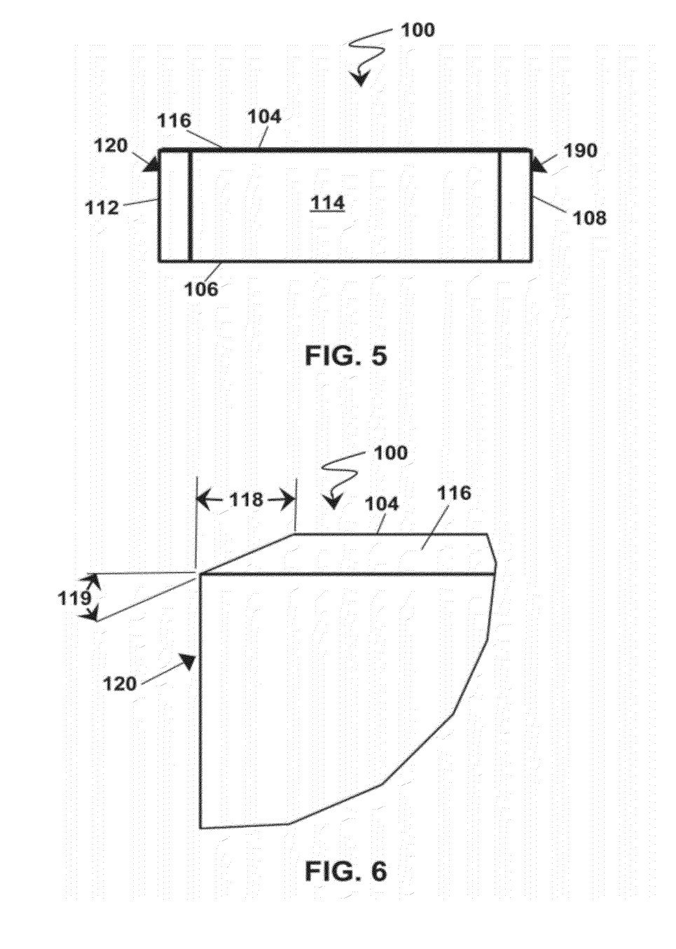

Referring to FIGS. 5 and 6, at least corner 120 may include a chamfer 116. The chamfer 116 may be provided along a perimeter of face 104. In alternative constructions, the chamfer 116 may be provided only along a portion of the perimeter of face 104 or may be provided along at least a portion of the perimeters of one or more of the other faces 106, 108, 110, 112, and 114.

The chamfer 116 may include a chamber width 118 and a chamfer angle 119. In the chamfer 116 shown in FIG. 6, the chamfer 116 has a chamfer width 118 of about 0.10 millimeters or about 0.004 inches, for example, and a chamfer angle 119 of about 25 degrees, for example, relative to face 104. However, embodiments are not limited to the chamfer width 118 and chamfer angle 119 described above. The exact chamfer width 118 and chamfer angle 119 may be determined by the application, use, or some other criterion of the insert 100. Also, the first and third arcs 122 and 126 and the first and third radii 128 and 132 may be determined from the chamfer width 118 or the chamfer angle 118 along with the shape of the insert 100, the second arc 124, the second radius 130, or some other feature of the insert 100.

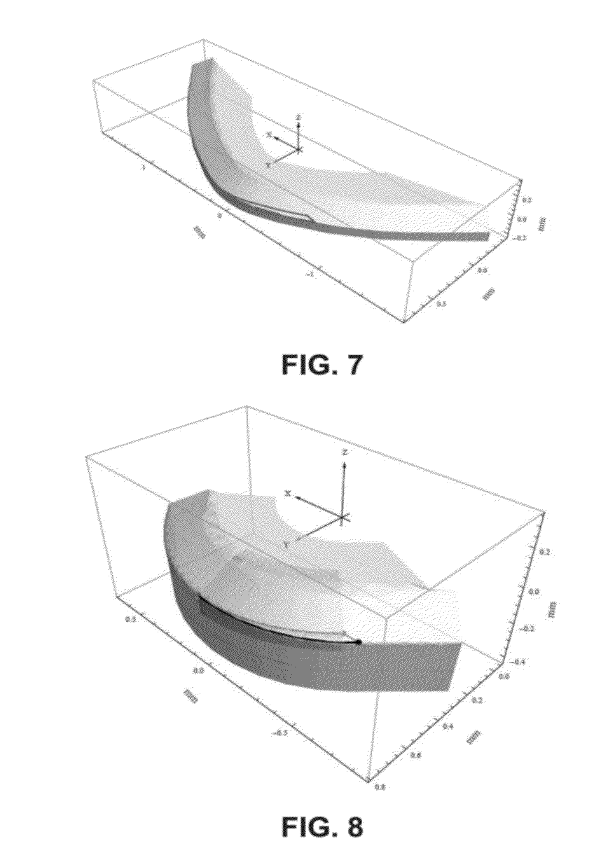

Referring to FIGS. 7-9, a cutting insert with a wiper on the leading edge is compared with a cutting insert with only a corner radius. The analysis shown in FIGS. 7-9 was completed with three dimensional modeling. The three dimensional modeling is described in “Surface Finish and Tool Wear Characterization in Hard Turning using Cutting Tool Representation in Mathematica” by Raja Kountanya. In the modeling of FIGS. 7-9, a polar coordinate system may be fixed to a center of the corner radius, and every point on the cutting edge may be referenced by the angle between a line joining the origin to the point and a fixed line in the plane on a top face of the insert. This may be referred to as the angular value or angular position. The bounds of the angular position designating the cessation of contact of the insert and a workpiece may be referred to as angular extremities of contact. The model may estimate the angular extremities of contact for given feed and depth-of-cut in conjunction with geometry parameters. The model may also allow estimation of uncut chip thickness at every point of the cutting edge engaged in contact with the workpiece.

FIG. 7 shows a cutting insert with a wiper. FIG. 8 shows a cutting insert with only a corner radius and no wiper. For the cutting inserts shown in FIGS. 7 and 8, the chamfer width is about 0.20 millimeters, for example; the chamfer angle is about 25 degrees, for example; an edge radius is about 0.005 millimeters, for example; a lead angle is about 45 degrees, for example; an inclination angle is about −5 degrees, for example; a normal rake angle is about −5 degrees, for example; a depth of cut is about 0.25 millimeters, for example; and the feed rate is about 0.075 millimeters per revolution, for example. For the cutting insert shown in FIG. 7, the wiper radius is about 3 millimeters, for example, and the wiper arc is about 25 degrees, for example.

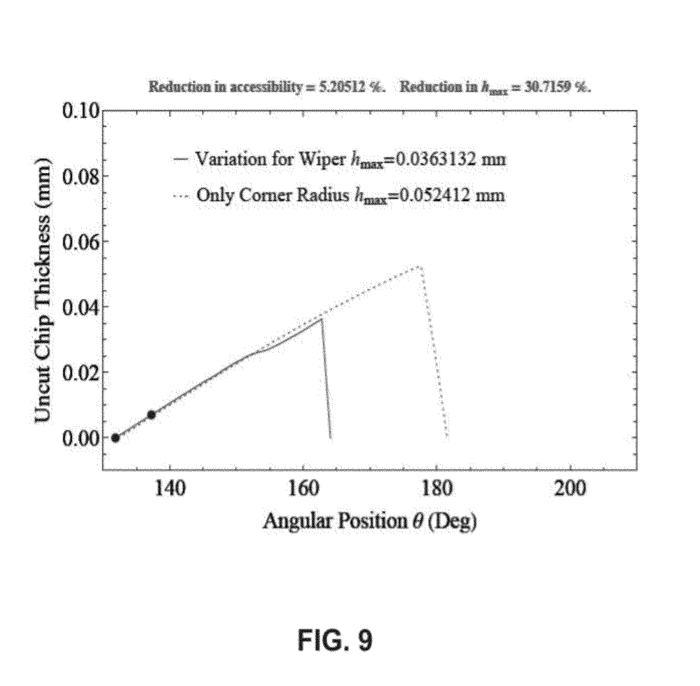

Turning to FIG. 9, a graph of uncut chip thickness versus an angular position is shown. The angular position is a position along a cutting edge of a cutting insert. Uncut chip thickness is shown in millimeters, and angular position is provided in degrees. Uncut chip thickness versus angular position was calculated for the same feed rate, depth of cut, and insert holder. The dotted line in FIG. 9 may represent the uncut chip thickness versus angular position along the cutting edge of the cutting insert with only a corner radius and without a wiper. The dotted line may indicate a maximum uncut chip thickness of about 0.052412 millimeters, for example, at an angular position of about 178 degrees, for example.

The solid line in FIG. 9 represents the uncut chip thickness versus angular position along the cutting edge of the cutting insert with a wiper. The dotted line indicates a maximum uncut chip thickness of about 0.0363132 millimeters, for example, at an angular position of about 162 degrees, for example. Thus, as shown in FIG. 9, for the same feed rate, depth of cut, and tool holder, the cutter with a wiper on the leading edge (shown in FIG. 7) shows an approximately 30% reduction, for example, in maximum uncut chip thickness with only an approximately 5% reduction, for example, in reach. As shown near the top of FIG. 9, the reduction in accessibility is 5.20512%, for example, and the reduction in maximum uncut chip thickness is 30.7159%, for example.

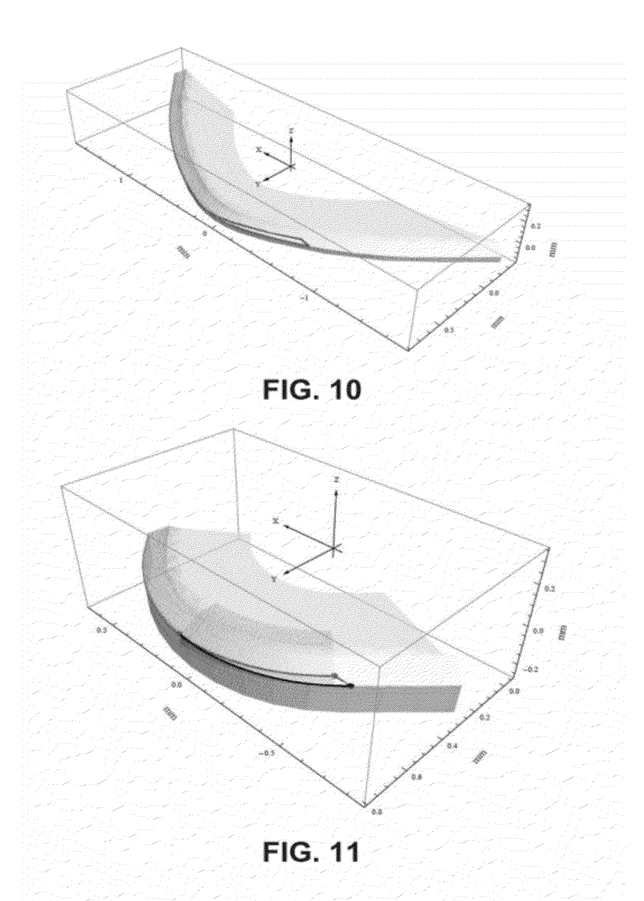

Referring to FIGS. 10-12, a cutting insert with a wiper on the leading edge may be compared with a cutting insert with only a corner radius. The analysis shown in FIGS. 10-12 may be completed with the same three dimensional modeling as for FIGS. 7-9. FIG. 10 shows a cutting insert with a wiper. FIG. 11 shows a cutting insert with only a corner radius and no wiper. For the cutting inserts shown in FIGS. 10 and 11, the chamfer width may be about 0.10 millimeters, for example; the chamfer angle is about 25 degrees, for example; an edge radius is about 0.005 millimeters, for example; a lead angle is about 45 degrees, for example; an inclination angle is about −5 degrees, for example; a normal rake angle is about −5 degrees, for example; a depth of cut is about 0.25 millimeters, for example; and the feed rate is about 0.075 millimeters per revolution, for example. For the cutting insert shown in FIG. 10, the wiper radius is about 3 millimeters, for example, and the wiper arc is about 25 degrees, for example. When comparing FIGS. 7-9 to FIGS. 10-12, the chamfer width is reduced from about 0.20 millimeters to about 0.10 millimeters, for example.

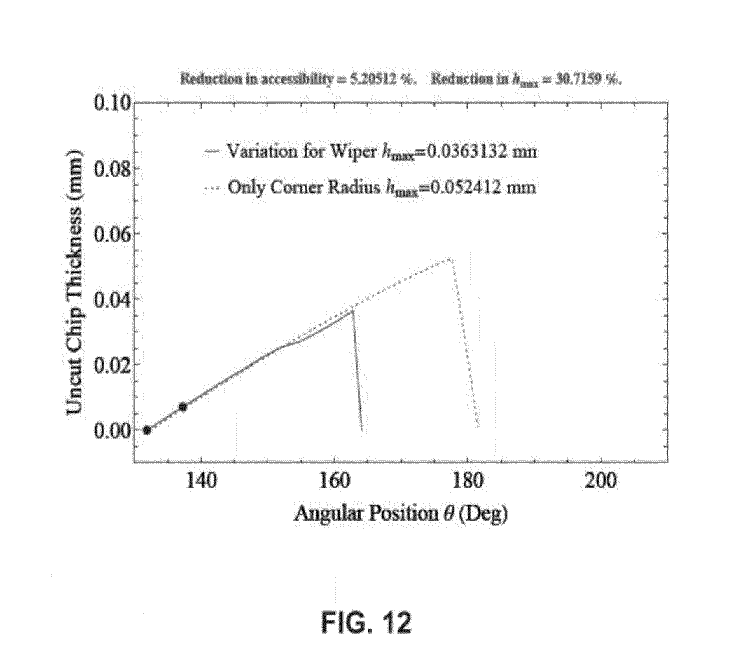

Turning to FIG. 12, a graph of uncut chip thickness versus an angular position is shown. The angular position may be a position along a cutting edge of a cutting insert. Uncut chip thickness is shown in millimeters, and angular position is provided in degrees. Uncut chip thickness versus angular position was calculated for the same feed rate, depth of cut, and tool holder. The dotted line in FIG. 12 represents the uncut chip thickness versus angular position along the cutting edge of the cutting insert with only a corner radius and without a wiper. The dotted line indicates a maximum uncut chip thickness of about 0.052412 millimeters at an angular position of about 178 degrees.

The solid line in FIG. 12 represents the uncut chip thickness versus angular position along the cutting edge of the cutting insert with a wiper. The dotted line indicates a maximum uncut chip thickness of about 0.0363132 millimeters, for example, at an angular position of about 162 degrees, for example. Thus, as shown in FIG. 12, for the same feed rate, depth of cut, and tool holder, the cutter with a wiper on the leading edge (shown in FIG. 10) shows an approximately 30% reduction, for example, in maximum uncut chip thickness with only an approximately 5% reduction in reach, for example. As shown near the top of FIG. 9, the reduction in accessibility is 5.20512%, for example, and the reduction in maximum uncut chip thickness is 30.7159%, for example.

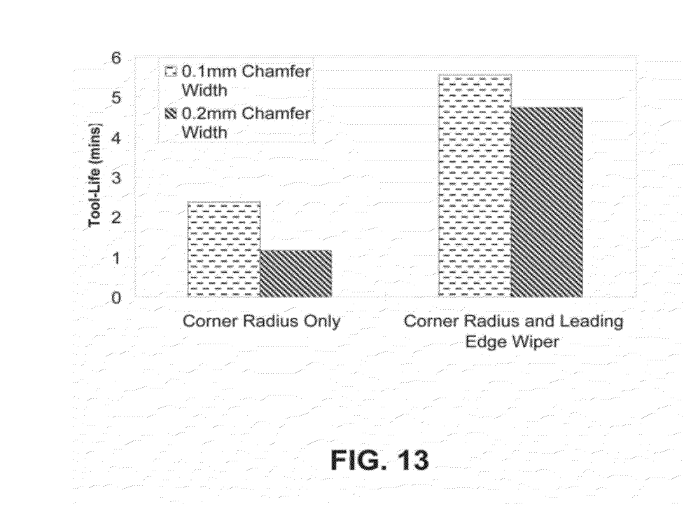

Referring to FIG. 13, results of machining tests are shown. FIG. 13 shows life in minutes for two sets of cutting inserts. One of the two sets may include results for a cutting insert with only a corner radius, and the other of the two sets may include results for a cutting insert with a corner radius and a leading edge wiper. The first set of data in the left side of the graph may be for cutting inserts with only a corner radius and no wiper. The second set to the right of the first set may be for cutting inserts with a corner radius and a leading edge wiper. Also, in each set, cutting inserts with two different chamfer widths are tested. In the first set, two cutting inserts may have the same corner radius; however, one has a chamfer width of 0.1 millimeters, for example, (bar shaded with broken horizontal lines), and the other has a chamfer width of 0.2 millimeters, for example, (the bar shaded with solid diagonal lines). In the second set, two cutting inserts may have the same corner radius and leading edge wiper; however, one may have a chamfer width of 0.1 millimeters, for example, (the bar shaded with broken horizontal lines), and the other has a chamfer width of 0.2 millimeters, for example, (the bar shaded with solid diagonal lines).

The conditions of the machining tests are similar to those of FIGS. 10-12. In particular, the chamfer width is about 0.10 millimeters, for example; the chamfer angle is about 25 degrees, for example; an edge radius is about 0.005 millimeters, for example; a lead angle is about 45 degrees, for example; an inclination angle is about −5 degrees, for example; a normal rake angle is about −5 degrees, for example; a depth of cut is about 0.25 millimeters; and the feed rate is about 0.075 millimeters per revolution, for example. For the cutting insert with a wiper, the wiper radius is about 3 millimeters, for example, and the wiper arc is about 25 degrees, for example. Furthermore, the work material of the cutting inserts was Wallex-3 or WX3, manufactured by Wall Colmonoy.

In FIG. 13, when comparing the first set of bars in the left side of the graph, which is for cutting inserts with only a corner radius and no wiper, with the second set of bars in the right side of the graph, which is for cutting inserts with a corner radius and a leading edge wiper, there is an increase in life for the cutting inserts with a corner radius and a leading edge wiper. Also, there is an increase in life for both cutting inserts having a corner radius and a leading edge wiper but a different chamfer width.

The insert 100 can be made from polycrystalline cubic boron nitride (PCBN), polycrystalline diamond (PCD), or some other suitable material. The exact material chosen for the insert 100 depends on the application, use, or some other criterion for the insert 100.

The insert 100 may be made with a computer numerical control (CNC) tool grinder or some other suitable device that may shape hard materials. If the insert 100 is made by using a CNC tool grinder, a predetermined amount of a suitable material may be inserted into the CNC tool grinder. A grinding wheel of the CNC tool grinder may be used to form at least corner 120 with predetermined first, second, and third arcs 122, 124, and 126, each with a respective predetermined first, second, and third radius 128, 130, and 132. That is, the CNC tool grinder may provide a predetermined corner radius without wipers or with a leading edge wiper, a trailing edge wiper, or both a leading edge and a trailing edge wiper. The CNC tool grinder may blend the first, second, and third arcs 122, 124, and 126 so that no sharp features appear between adjacent arcs 122, 124, and 126. The CNC tool grinder may also provide a chamfer 116 with a predetermined chamfer width 118 and chamfer angle 119.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. Although described in connection with a particular embodiment thereof, it will be appreciated by those skilled in the art that additions, deletions, modifications, and substitutions not specifically described may be made without department from the spirit and scope of the invention as defined in the appended claims. Finally, the steps of all methods described herein can be performed in any suitable order unless otherwise indicated herein or otherwise clearly contradicted by context.

The terminology used herein is for the purpose of describing the particular embodiments and is not intended to be limiting of exemplary embodiments of the invention. The words “mechanism” and “element” are used broadly and are not limited to mechanical or physical embodiments. The use of any and all examples, or exemplary language (e.g., “such as”) provided herein, is intended merely to better illuminate the invention and does not pose a limitation on the scope of the invention unless otherwise claimed. No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

For the sake of brevity, conventional aspects of the various embodiments may not be described in detail. It should be noted that many alternative or additional functional relationships or physical connections may be present in a practical device.

Numerous modifications and adaptations will be readily apparent to those of ordinary skill in this art without departing from the spirit and scope of the present invention as defined by the following claims. Therefore, the scope of the invention is defined not by the detailed description of the invention but by the following claims, and all differences within the scope will be construed as being included in the invention.

What is claimed is:

1. A cutting insert comprising:
a body formed with at least one corner, the corner formed with at least a first radius and a second radius disposed adjacent the first radius wherein said cutting insert is adapted to be a part of a cutting tool.

2. The cutting insert of claim 1, wherein the first radius forms a wiper on a leading edge of the at least one corner.

3. The cutting insert of claim 1, wherein the second radius is a standard radius.

4. The cutting insert of claim 1, further comprising a third radius disposed adjacent the second radius.

5. The cutting insert of claim 4, wherein the first radius and the third radius are the same.

6. The cutting insert of claim 1, wherein the first radius is adapted to produce chip thinning effect and increase life in machining.

7. The cutting insert of claim 4, wherein the second radius provides a first predetermined reach, and the first radius, the second radius, and the third radius combined provide a second reach that is approximately 5% smaller than the first reach.

8. A method of manufacturing a cutting insert, comprising:
providing a body; and
forming a corner on the body with a first radius and a second radius disposed adjacent the first radius.

9. The method of claim 8, further comprising forming the first radius as a wiper on a leading edge of the corner.

10. The method of claim 8, further comprising forming the second radius with a standard radius.

11. The method of claim 8, further comprising forming a third radius disposed adjacent the second radius.

12. The method of claim 11, further comprising forming the third radius with a same radius as the first radius.

13. The method of claim 8, further comprising producing chip thinning effect and increasing life in machining.

14. The method of claim 11, further comprising
forming the second radius to provide a first predetermined reach, and
forming the first radius, the second radius, and the third radius together to provide a second reach that is approximately 5% smaller than the first reach.

15. A cutting insert comprising:
a body formed with at least one corner, the corner formed with at least a first radius and a second radius disposed adjacent the first radius, wherein said cutting insert is adapted to be a part of a cutting tool and wherein the first radius forms a wiper on a leading edge of the at least one corner.
